(19) United States
(12) Patent Application Publication
(10) Pub. No.: US 2012/0302228 A1
(43) Pub. Date: Nov. 29, 2012

(54) Remote Power Microgenerator Device and Method

(76) Inventor: Peter Gray, Redway, CA (US)

(21) Appl. No.: 13/482,021

(22) Filed: May 29, 2012

Related U.S. Application Data
(60) Provisional application No. 61/490,416, filed on May 26, 2011.

(51) Int. Cl. H02J 3/38; H04W 88/04

(52) U.S. Cl. 455/422.1; 307/69

(57) ABSTRACT

Disclosed is a microgenerator device adapted to retrofit into an existing utility power grid and provide a local means of power generation in remote locations, a relay communication means and a charging station for an electric car. Further disclosed is a method of use, wherein an electrical microgenerator is utilized to locally contribute power to an electrical grid, store power locally and supply users in remote areas with a means of communication and local power access. The microgenerator device comprises a direct current power generator assembly having a vertical axis wind turbine, a photovoltaic array, a micro-inverter, a telephonic communications relay capability, and energy storage unit, wherein the assembly is connectable to an existing power grid and utility pole. The device provides supplemental power to the grid, provides local power access and storage, while also providing a means of communication in remote locations.

### CROSS REFERENCE TO RELATED APPLICATION

This application claims the benefit of U.S. Provisional Application No. 61/490,416 filed on May 26, 2011, entitled “Rural Microgeneration Smartgrid.” The patent application identified above is incorporated here by reference in its entirety to provide continuity of disclosure.

### BACKGROUND OF THE INVENTION

1. Field of the Invention

The present invention relates to power generation and electrical power grids. More specifically, the present invention relates to a microgenerator assembly that generates local power via a vertical-axis wind turbine and photovoltaic cell, wherein the power is input directly into an electrical power grid or stored locally for offsetting power demand in peak hours, providing a local charging station and a telephonic communications relay service in remote locations.

Power generation and access to electrical power can be a common issue for those living in remote areas and distances away from a utility power generation facility. Undeveloped areas may have a scarce source of power or lack of transmission lines to remote or desolate locations. Further, increased distances from a power generation source results in larger transmission resistance and therefore lower voltage, limiting the availability of adequate or available electrical power. During periods of peak power usage or extreme environmental conditions, it is common for these areas to experience rolling brown-outs or local outages, wherein access to electrical power is ceased for periods of time due to high demand and physical limitations of the grid. Further still, those living in remote areas may have limited means of communicating with a utility company with respect to the condition of their transmission lines or an emergency situation, wherein local gaps in transmission or outages caused by transmission line damage can take consider time to correct as ready notification is not possible.

Another issue facing existing electrical grids, and not specifically for those living in remote areas, is the generation of power from renewable sources. Green energy and alternative energy is a rapidly expanding sector in the energy market, particularly as energy prices increase, fuel reserves dwindle and the environmental impact of certain forms of energy comes under higher scrutiny. Green energy, or sustainable energy, is considered those forms of energy that are generated from renewable and sustainable sources, and those that do not adversely affect our global climate. In the area of electrical power and distribution, recent proposals include those that require incorporation of a certain percentage of generated and distributed power to be derived from renewable resources. Entire industries are forming to meet this new demand for sustainable energy creation, creating technologies in the area of wind, solar, hydroelectric, geothermal and tidal energy.

The present invention is comprises an energy generation, storage and access device that is capable of connecting directly to existing electrical distribution lines, wherein a plurality of microgenerator devices are positioned in succession along utility poles for generating local power, providing electrical charging access and storage points, and also providing a plurality of functions specifically for users in remote locations. The goal is to improve local access to electrical power, and to further assist an electrical grid by inputting locally generated and renewable energy thereinto. The device of the present invention is a microgenerator having a vertical access wind turbine and photovoltaic array for generating direct current electricity via wind and solar energy. A micro-inverter transforms the generated direct current voltage into alternating current power that is sufficient for introduction directly into an existing electrical grid, or alternatively the direct current is fed into a local power storage unit positioned at the base of the utility pole for storing power for use during periods of high demand and peak usage hours, or for use as an electric car charging station. Also provided is a cellular transceiver for achieving a telephonic connection between successive microgenerator devices, whereby a voice signal may be transmitted from one device to another for contacting an electric company or emergency responder from a remote location absent of cellular connectivity.

2. Description of the Prior Art

Several devices have been disclosed in the prior art that relate to supplemental grid power generation. These include devices that have been patented and disclosed in published patent application publications, and specifically those that relate to small scale wind and solar generation units that are attachable to existing electrical grids. Further disclosed are those that are attachable to electrical utility poles for inputting power directly into the power grid. These devices provide a means to input power into an electrical grid and function as local power generating sources; however these devices are not particularly suited for the specific use or intention of the present invention. It is desired to disclose a microgenerator device and method of use that is particularly suited for rural and more remote locations, wherein the a source local power generation, storage and offset device is provided for individuals who may experience brown-outs due to lack of adequate access to power during certain environmental or high demand scenarios, and further it is desired to disclose a device that offers local power access and a means of communication between successive microgenerator units. The following is a summary of those devices deemed most relevant to the present invention, wherein their elements are discussed for the purposes of highlighting their drawbacks and differences.

Specifically, U.S. Published Patent Application Publication No. 2009/0224606 to Gandy discloses a distributed electrical generation system comprising a plurality of wind turbine generators for converting wind energy into low voltage AC electrical power. The wind turbines are vertical axis turbines rotatable about a shaft connected to an electric generator for generating low voltage AC power. The system includes utility pole mounting assemblies for mounting to electric distribution systems of existing power grids. A plurality of transformers transform the low voltage AC power into medium voltage AC power compatible with existing electric distribution systems. While disclosing a wind power generation unit that is mounted to an electrical grid distribution network and connected to an existing electrical grid, the Gandy device is limited to wind power generation and in-line input of power into the grid. The Gandy device does not contemplate a power generation means having a plurality of power generating devices and for use in rural areas wherein local power supply and communication capabilities are limited. The present invention provides a power generation unit that can input power into a local grid, and further provide local access to power and a means to power cellular connectivity in remote areas. The present invention provides improved novelty and flexibility with respect to its deployment, and is not limited to supply supplementary grid power.

U.S. Published Patent Application Publication No. 2011/0025070 to Price is another device that discloses a vertical access wind turbine system for distributed power generation for a utility grid, comprising an overhead support member, a rotor shaft, a plurality of wind vanes, a generator and a transmission line connect to the generator for electrification of a utility grid. The device provides a wind turbine attachable to a utility pole for direct input of wind power into a grid. Similar to the Gandy disclosure, the Price device is one that relies solely on wind power and provides power input directly into an electrical grid. The present invention provides a flexible power generator that utilizes both wind and solar energy for input into an electrical power grid, while also providing an input for a local power source to power electric cars and power a cellular transceiver, expanding cellular networks and power sources to more rural or remote locations.

Further, U.S. Published Patent Application Publication No. 2011/0017256 to Stevens discloses a solar power generation system, comprising thin film solar array, a micro-inverter and a gateway communications unit. The gateway communications unit is connectable to a power grid, and the thin film solar array is connectable to a utility pole, light pole or windmill device for supplying supplemental solar energy to a utility grid. While offering a unique means of attaching solar arrays to existing structures and supplementing the utility grid with an alternative source of energy, the Stevens device merely discloses a solar array connected to a power grid. The present invention provides two means of power generation and a device that diverges in spirit and structure.

Finally, U.S. Published Patent Application Publication No. 2010/0295319 to Britnell discloses a hubless wind turbine generator adapted to surround an elongated member or pre-existing structure. The hubless wind turbine includes a set of wind-driven blades rotatable about a central axis, a generator having an annular magnetic armature and annular stator for creating an assembly that is capable being supported about its annular interior and generating electrical power via the rotation of the device by wind power. The hubless design of the device allows the assembly to be connected to an upstanding pole or structure, including a utility pole or support for a water tower. The Britnell device provides a uniquely designed wind turbine device that is attachable to a structure through its interior, providing connection to an existing structure and minimizing its outward cross section. The present invention provides a vertical axis wind turbine having a centrally rotatable driveshaft, along with a photovoltaic solar cell unit, wherein the unit provides a flexible power generation means that is preferably attachable to the top of utility poles and connected to an electrical utility grid.

The present invention is a local power generator and source from which electrical energy may be drawn and communication can be established. Its function is primarily to improve power access and communication in remote locations, which can be limited in certain regions due to lack of adequate infrastructure or the distance from a power source. It is submitted that the elements of the present device and steps of the present method are substantially divergent in design and intent from the prior art, and consequently it is clear that there is a need in the art for an improvement to existing electrical microgenerator devices. In this regard the instant invention substantially fulfills these needs.

### SUMMARY OF THE INVENTION

In view of the foregoing disadvantages inherent in the known types of electrical microgenerator devices now present in the prior art, the present invention provides a new device and method wherein the same can be utilized for providing convenience for the user when supplying local access and generation of power in conjunction with an existing utility grid, and further providing a means of communication in remote locations.

It is therefore an object of the present invention to provide a new and improved electrical microgenerator devices that has all of the advantages of the prior art and none of the disadvantages.

It is another object of the present invention to provide a microgenerator device that is connectable to an existing utility pole and further connectable to an electrical utility grid, wherein locally generated power may be input into the grid during high demand times or for general contribution to the power grid.

Another object of the present invention is to provide a microgenerator device that generates power via a vertical axis wind turbine and a photovoltaic solar array, wherein the power is generated from sustainable sources and available for local consumption or distribution into a power grid.

A further object of the present invention is to provide a microgenerator device that optionally stores locally generated power or electrical power from the grid during non-peak times, allowing access to the stored energy for use as a charging station or for distribution during peak hours when energy from the power station is more expensive.

Yet another object of the present invention is to provide a microgenerator device that further comprises a means of voice communication between units, wherein access to telephonic communication is possible in remote and rural locations wherein cellular communication may not be readily available.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention attached to an existing utility pole for generating local power.

FIG. 2 shows a perspective view of a plurality of microgenerator devices attached to successive utility poles for power generation, power storage, and voice communication purposes.

### DETAILED DESCRIPTION OF THE INVENTION

Reference is made herein to the attached drawings. Like reference numerals are used throughout the drawings to depict like or similar elements of the microgenerator device. For the purposes of presenting a brief and clear description of the present invention, the preferred embodiment will be discussed as used for locally contributing to a power grid, storing power locally, providing local power access, and further providing a means of communication in remote locations wherein these functions may not be readily available. The figures are intended for representative purposes only and should not be considered to be limiting in any respect.

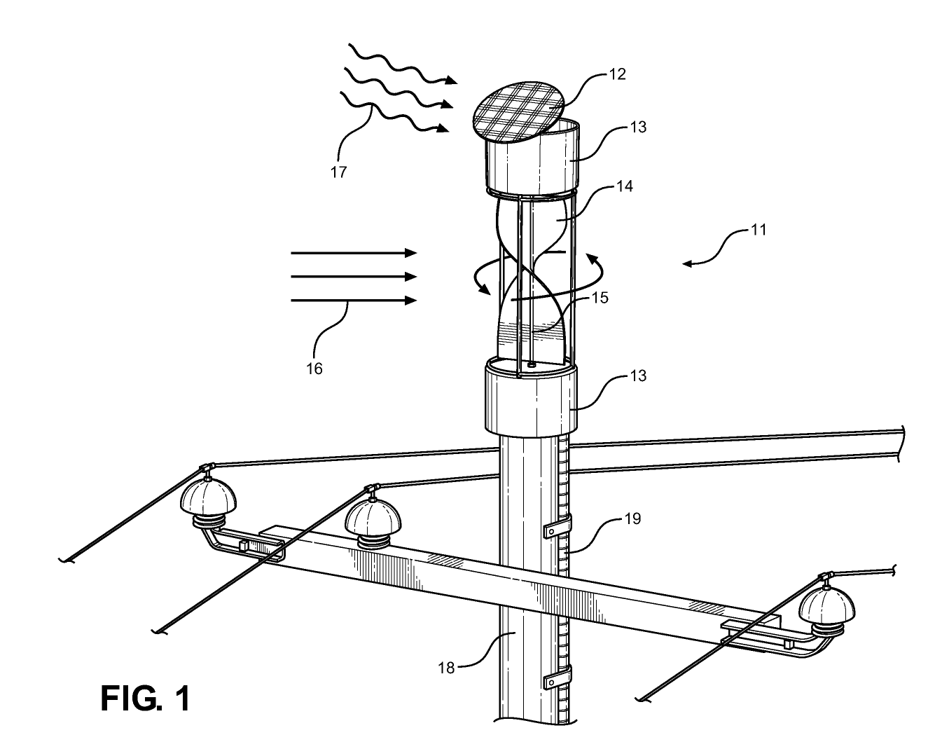

Referring now to FIG. 1, there is shown a close-up perspective view of the microgenerator device 11 of the present invention in a working position and attached to a utility pole 18. The microgenerator unit 11 comprises a vertical axis wind turbine 15 that is mounted between two end caps 13 containing circuitry and support elements for the wind turbine 14 to spin about its axis 15. Above the upper end cap 13 is a photovoltaic array 12, which develops direct current electrical energy from sunlight for direct use or to be fed into a micro-inverter within the end cap for transformation of the direct current energy into alternating current that is compatible with the electrical power grid. Electrical power is transmitted through a conduit 19 directly to the electrical lines of the grid, or alternatively routed to a local electrical power storage unit at the base of the utility pole 18. The storage unit provides a means of storing energy for use locally or for distribution into the grid during high usage and peak cost times, when energy developed from the main power station is most expensive.

The vertical axis wind turbine 11 of the present invention provides a compact means of generating energy from wind power, while its placement along the top of utility poles 18 contributes to the ability of the device to accept freely moving air 16 that is not disturbed by the ground, wherein its proximity thereto may otherwise reduce the velocity and flow rate of the stream of air utilized by the turbine blades. The turbine itself comprises a contoured blade 14 section that attaches to a central, rotatable driveshaft 15. The driveshaft 15 is spun by the load on the blades 14 due to the air pressure, wherein the driveshaft 15 connects to a transmission and to an electrical generator in the lower cap 13 of the assembly. The generator creates direct current electricity, which can be fed directly through the conduit 19 and into a storage unit, or alternatively transformed by an inverter and fed into the electrical grid. The use of a vertical axis wind turbine allows for a more compact assembly, reduces the structural loads on the device chassis compared to larger wind turbine blades, and further allows a plurality of turbines to be aligned along consecutive utility poles 18 without addressing aerodynamic interference issues related to relative spacing.

The photovoltaic cell 12 of the present microgenerator is one that is utilized in conjunction with the wind turbine 11 to generate direct current electricity. The cell 12 is one that utilizes sunlight 17 to create electricity, wherein the cell is placed along the upper portion of the assembly and may further be directed toward the horizon or toward an area of the sky wherein the sun is most directly engaged. This feature allows the cell 12 to be utilized effectively in areas of higher latitude and further in seasons wherein the sun is lower in the sky. Similar to the wind turbine, electricity generated from the cell 12 is either fed directly into the energy storage unit at the base of the utility pole 19, or is alternatively routed through a micro-inverter, wherein the direct current is transformed into alternating current suitable for direct introduction into the electrical grid.

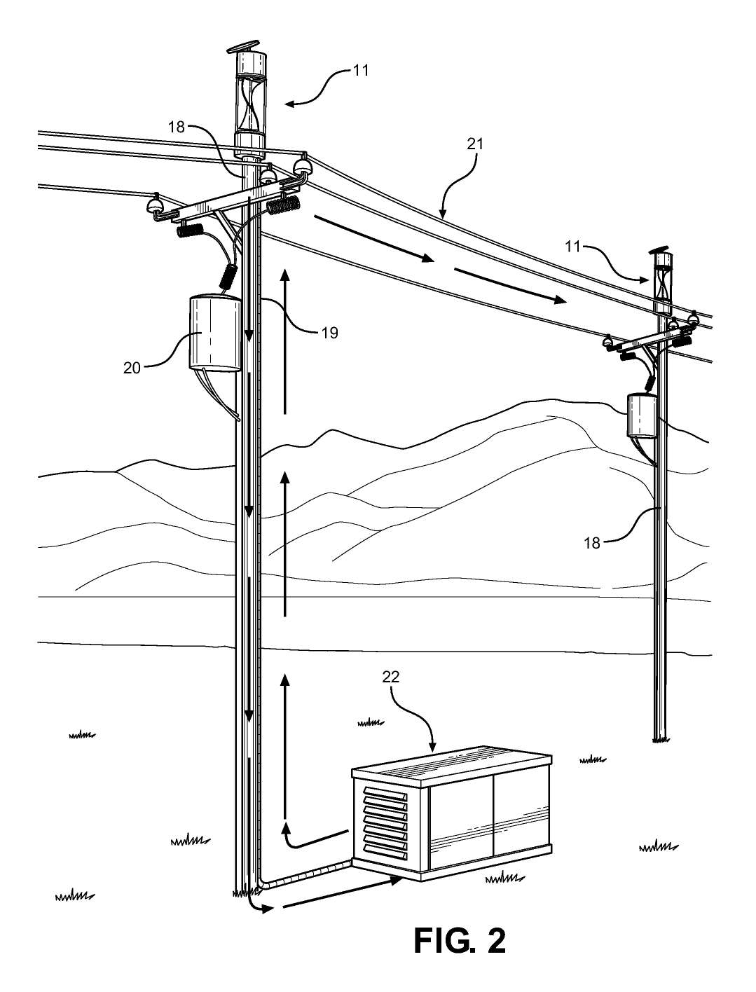

Referring now to FIG. 2, there is shown a view of the microgenerator of the present invention installed on a series of utility poles 18 in a remote location. Each microgenerator unit 11 is installed along the upper region of the utility pole 18 to allow for free moving air to spin the turbine, and to prevent ready theft of the assembly once installed. The solar cell and the vertical axis wind turbine provide two means of generating electricity, which can be input directly into the electrical grid 21 or stored locally in an energy storage unit 22 at the base of the utility pole 18. The storage unit 22 comprises a means to store electricity in the form of batteries or similar means, wherein the energy can be harnessed locally from the unit 22 itself, or be fed back into the system during brown-outs or when peak energy demand is highest and most expensive. Electricity can further be siphoned from the grid via the utility pole transformer 20, whereby the electricity is reduced into a form usable and storable by the storage unit 22. In remote locations where access to power may be limited, the energy storage unit may offer a receptacle or means of charging an electric car that is low on power and far from a charging station. In this way, the unit 22 offers local power access in otherwise remote areas.

Further provided within the microgenerator and present in its end cap is a cellular transceiver or similar communication means, which is relays signals between successively installed units 11 to transmit voice communication therebetween. A telephonic interface and means of receiving a cellular signal from a handset is provided, wherein a user may achieve cellular or similar telephonic connectivity. It is desired that this capability be provided in more remote locations wherein cellular coverage is not readily available. In the event of a damaged or inactive power line, or in the event of an emergency situation, it is contemplated that this means of communication allow for an individual to reach a utility company or operator assistance for communicating with authorities or emergency services. It may otherwise be difficult for an individual to contact a utility company or emergency services in remote areas, which can cause extended power outages or life threatening situations in certain emergency scenarios. The present invention is adapted to provide electrical power generation, access and storage, and further the ability to communicate via the units for improved services access.

The installation of the present invention is also a further benefit over larger wind or solar cell farms, which occupy a large area of land and must follow particular regulations with respect to obtaining, operating and servicing the space in which the farm is located. In remote areas, and even developed and more congested areas, the use of the present invention provides the advantage of a low spatial footprint, wherein no permits or large plots of land are required to generate, store and provide access to electricity, while further providing a means of communication.

The present invention provides a device that enables utility companies to generate power with a series of piggy-backing and utility pole-mounted assemblies, and further provides users within a community or on the road in rural areas with electrical power and communication access. The device itself comprises of a series of modular units mounted on top of utility poles, each having a vertical-axis wind turbine, a solar cell panel, and a micro-inverter for transforming the direct current to usable or distributable alternating current. In addition, each unit can contain a cell phone transceiver for creating a phone relay system, which is operable with existing cellular phones or provides a telephone interface at the base of the utility pole. By using this system, companies can capitalize on and recycle existing equipment and already-constructed utility poles, as opposed to having to build their own, while individuals are benefited by having ready access to power and secondary power sources in the event of brown-outs or during periods of high demand.

Associated with the present device is an associated method, which comprises the use of microgenerator units mounted to utility poles to generate, store, and provide access to a source of electrical power. It further comprises the ability to provide a local source of energy, wherein users may charge their electric vehicles or other electrical devices when necessary. The method further comprises the use of such a microgenerator to contribute to the electrical grid power, or alternatively to provide a secondary means of power during high demand periods or environmental conditions that cause local brown-outs. Finally the method contemplates the use of the microgenerators as a means of relaying communication through cellular or similar telephonic connectivity, whereby individuals in remote locations may reach utility companies and emergency services during periods of distress when cellular connectivity is not readily available.

The present device and method allows utility companies to use already-existing utility poles in remote areas to generate, store and provide local access to electrical power. A series of these modules are utilized in conjunction with existing power lines, piggybacked onto the existing tertiary distribution grid, which can contribute to the power grid, or further lead to a large battery bank located at the base of the distribution line in an appropriate structure. This battery bank can be connected to the grid via a larger utility inverter, allowing the energy generated to be uploaded to the grid as a net gain. In addition, main battery storage facilities located in proximity to roadways, as many rural power lines are, can serve as emergency recharging stations for electric vehicles. The cell transceivers incorporated into each unit can serve two functions: extending phone service into rural areas not currently covered by existing networks, and allowing utility companies to monitor conditions and diagnose problems along the line. The present device and method may be utilized by any utility company looking to expand their portfolio of power generating means and improving access to electrical power in remote locations.

In light of the present disclosure, it is herein submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A remote electrical power generating, storing and access device, comprising:
a microgenerator assembly having a vertical axis wind turbine, a solar cell, a micro-inverter, and a conduit for transmitting electricity;
said wind turbine comprising at least one contoured blade driven by wind power, wherein said blade is mounted to a driveshaft turning an electrical generator for generating direct current electricity;
said solar cell generating direct current electricity via light;
said micro-inverter adapted to accept said generator or said solar cell direct current and transform it into alternating current;
said assembly being mountable to a electrical utility pole;
said storage unit being capable of feeding power directly into a utility grid, or alternatively provide a local means of distributing power.

2) The device of claim 1, further comprising:
an electrical energy storage unit for storing said direct current from said wind turbine and/or said solar cell;
said local means of distributing power comprising an electrical receptacle or electrical connector from said storage unit.

3) The device of claim 2, wherein said electrical energy storage unit comprises a housing having one or a plurality of batteries for storing energy.

4) The device of claim 1, wherein said microgenerator further comprises:
a telephonic connectivity means between successively installed microgenerators for relaying voice communication from a first microgenerator a remote location to a receiver.

5) The device of claim 4, wherein said telephonic connectivity means further comprises a cellular transceiver that transmits voice signals wirelessly between microgenerators.

6) The device of claim 4, wherein said telephonic connectivity means further comprises a telephone interface for a user to speak into and listen from.

7) The device of claim 4, wherein said telephonic connectivity means further comprises a means to accept and transmit short distance cellular signals from a user handheld device.

8) A method of generating, storing and providing access to electrical power in remote locations, comprising the steps of:
mounting a microgenerator assembly having a wind turbine and solar cell to one or a plurality of electrical utility poles;
positioning an energy storage means at a base of at least one utility pole for storing electricity from said utility pole grid power and/or said microgenerator;
providing a means to access said storage means for local access to electricity.

9) The method of claim 8, further comprising the steps of:
providing a means of telephonic communications between said microgenerator assemblies to allow voice communication therethrough.

10) The method of claim 9, further comprising the steps of:
establishing said telephonic communication between a user and a utility company or emergency services.
